(19) United States
(12) Patent Application Publication
(10) Pub. No.: US 2007/0113113 A1
(43) Pub. Date: May 17, 2007

(54) Data Processing Arrangement

(75) Inventors: Christian Sauer, Ottobrunn (DE); Soeren Sonntag, Munchen (DE); Matthias Gries, Ottobrunn (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/539,121

(22) Filed: Oct. 5, 2006

(30) Foreign Application Priority Data
Oct. 5, 2005 (DE) 102005047619.8-53

(51) Int. Cl. G06F 1/00

(52) U.S. Cl. 713/322; 713/320

(57) ABSTRACT

A data processing arrangement including a plurality of processing units. Each processing unit has a processing element, a data memory, a fill level unit, and a control unit. The processing element processes data stored in the data memory, or the data memory stores results of data processing performed by the processing element. The fill level unit generates a fill level signal signaling an amount of data stored in the data memory. The control unit controls processing power of the processing element based on the fill level signal.

### CROSS-REFERENCE TO RELATED APPLICATION

This application claims priority to German Patent Application Ser. No. 10 2005 047 619.8-53, which was filed on Oct. 5, 2005, and is incorporated herein by reference in its entirety.

### TECHNICAL FIELD

The invention relates to a data processing arrangement and to a method for controlling a data processing arrangement.

### BACKGROUND OF THE INVENTION

In data processing devices, particularly those arranged in devices, such as, for example, in embedded systems, low power consumption is desirable.

### BRIEF DESCRIPTION OF THE FIGURES

Exemplary embodiments of the invention are shown in the figures and will be explained in greater detail in the text which follows.

FIG. 1 shows an embedded system according to an exemplary embodiment of the invention.

FIG. 2 shows a processing block according to an exemplary embodiment of the invention.

FIG. 3 shows an evaluating logic according to an exemplary embodiment of the invention.

FIG. 4 shows a node control according to an exemplary embodiment of the invention.

### DETAILED DESCRIPTION OF THE INVENTION

Embedded systems are electronic systems which are integrated into a larger overall system. They are designed for special applications and execute dedicated functions within the overall system. Within the framework of the overall system, embedded systems interact with their environment. They register and process external events. Since the type and frequency of these external events typically do not deterministically vary, embedded systems and their components are subject to fluctuating load requirements.

For example, in the case of an embedded system which is used for packet processing, both the time of arrival of a data packet and the type of the data packet are non-deterministic. The effect of fluctuating load requirements is increased further due to the fact that events of different type frequently also require a different processing effort (service time) and that for events of different type, there are frequently also different requirements for the speed of processing of the events.

In packet-processing systems, for example, data packets of different service classes require a different processing speed, for example data packets for voice data, video data and other data (text data such as, for example, emails). Voice data, for example, require fast real-time processing so that noticeable delays are avoided (real-time application). In the case of the processing of data such as, for example, emails, there are no special requirements for the processing time (a so-called best-effort processing is sufficient).

In the case of fluctuations in the load requirement for an embedded system, it is difficult to estimate what processing power must be provided by the embedded system. Typically, embedded systems are dimensioned for a worst-case scenario, or with a reserve of processing power so that any load peaks which may occur can be accommodated. However, this leads to parts (for example certain components) of an embedded system not being optimally utilized but still consuming power.

To minimize the power consumption of an embedded system, the load situation of the system must first be determined. On the basis of this, the current processing power may be reduced, if necessary, as a result of which a reduction in the power consumption can be achieved.

Embedded programmable systems for data flow-oriented fields of application such as, for example, for packet processing or image processing frequently consist of a number of processing nodes (components) which communicate data to one another by means of system events (for example messages).

According to an exemplary embodiment of the invention, an efficient possibility for reducing the power consumption of embedded systems is created with a multiplicity of processing nodes.

According to an exemplary embodiment of the invention, an arrangement for data processing includes a plurality of processing elements in which a data memory is allocated to each processing element and each processing element is set up for processing the data stored in its associated data memory or storing results of the processing of data in the data memory. To each processing element, a fill level unit is furthermore allocated which is set up for generating a fill level signal signaling an amount of data stored in the data memory allocated to the processing element. Furthermore, a control unit is allocated to each processing element, and controls processing power of the processing element based on the fill level signal generated by the fill level unit allocated to the processing element.

According to a further exemplary embodiment of the invention a method for controlling a data processing arrangement according to the arrangement for data processing described above is provided.

The arrangement for data processing is, for example, an embedded system for data flow-oriented applications. Due to the amounts of data to be processed and hard boundary conditions, for example for the processing speed and the costs of the embedded systems, these typically consist of a number of processing blocks. If the processing blocks, which in each case exhibit a processing element (e.g. a microprocessor), are decoupled from one another by means of data memories, for example input queues which temporarily store the data to be processed by the processing block for each processing block, an embodiment of the invention can be used for controlling the processing power of the processing blocks.

The finding forming the basis of one embodiment can be seen in that the fill level of the data memories reflects the frequency of events which are to be processed by a processing element or have already been processed. In the case of an input queue, a high fill level indicates that events must be processed frequently by the respective processing block. Events (or tokens) are, for example, data packets (possibly of different length), for example with sensor data, for example when using the arrangement in an embedded system for engine control in a car or frame data for image processing which, for example, are delivered regularly by a digital camera.

In the embodiment described below, the fill level signals are combined by means of an efficient evaluating logic with the control unit which implements a combination of clock gating and frequency adaptation. Higher fill levels produce an increase in the processing power so that all events can be processed in time. It is also possible to use an implementation of hysteresis effects as in the case of voltage scaling for controlling the processing power.

An embodiment of the invention provides a decentralized possibility, which can be implemented with little hardware requirements, for controlling the processing power, for example of embedded systems, and a resultant reduction in power consumption. The embodiment is decentralized and scaled in a simple manner to the number of processing elements. In the embodiment described below, both complete deactivation of a processing element (in the case of an empty input queue) and gradual adaptation of the processing power (by setting the clock frequency) are possible. Furthermore, dynamic, inertia-free fine-grained load detection and node control are possible. The embodiment described below utilizes the existing infrastructure of a system in which processing nodes are provided with input queues and can be achieved with little hardware expenditure, therefore. Furthermore, no operating system overhead is required for measuring the load and for controlling the processing power.

The data memory allocated to a processing element can also be used as an output queue. In this case, the control unit can operate reciprocally to the case of an input queue, that is to say the processing power of the processing element is reduced with high fill levels of the data memory. This prevents overloading of the data memory, that is to say of the output queue, and any losses of events at the output of the processing element.

Embodiments described in conjunction with the arrangement for data processing correspondingly apply also to the method for controlling a data processing arrangement.

The control unit allocated to a processing element can control the clock rate of the processing element or the supply voltage of the processing element on the basis of the fill level signal generated by the fill level unit allocated to the processing element. Similarly, the control unit can be switched off completely, for example by switching off the clock, when the data memory is empty. The processing power of the processing element can thus be controlled in a flexible manner.

The data memory allocated to a processing element is, as mentioned above, for example, an input queue in which data are stored which are to be processed by the processing element. Since the fill level of an input queue provides an indication of how high the required processing power of the processing element is, the processing power can be controlled efficiently on the basis of the fill level of an input queue.

The data stored in the input queue can be processed by the processing element in accordance with any sequence control method (such as, for example, FIFO, LIFO or according to a prioritization of the data).

A number of data memories which are set up for storing data which are to be processed by the processing element can be allocated to at least one processing element. The fill level unit allocated to the processing element can be set up in this case for generating a fill level signal by means of which an information item about the amount of data stored in the data memories is signaled. Furthermore, the number of data memories can be prioritized with respect to one another and the fill level signal can be generated on the basis of the prioritization of the number of data memories. For example, the data memories are weighted in accordance with their prioritization so that the processing power of the respective processing element is considerably increased when a data memory with high priority has a high fill level. Thus, embodiments of the invention also supply a possibility for controlling the processing power in the case of more complex architectures.

As mentioned, the data memory allocated to a processing element can also be an output queue in which data are stored which have been processed by the processing element.

In one embodiment, an input signal for the respective control unit is generated from the fill level signal in accordance with a hysteresis and the control unit controls the processing power of the respective processing element on the basis of the input signal.

In one embodiment, the processing elements are programmable. For example, the processing elements are microprocessors.

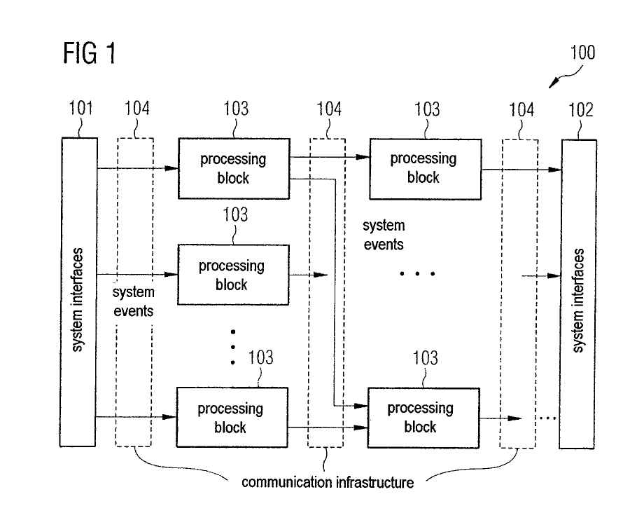

FIG. 1 shows an embedded system 100 according to an exemplary embodiment of the invention.

The embedded system 100 has input system interfaces 101 and output system interfaces 102. The embedded system 100 has a plurality of processing blocks 103 which are coupled to one another by means of a communication infrastructure 104. By means of the input system interfaces 101, the embedded system is supplied with system events, for example data packets, which are to be processed by the embedded system 100.

The system events are processed by the processing blocks 103. The processing blocks 103 can perform various processing steps and a system event, for example, is first processed by a first processing block 103 and then forwarded by means of the communication infrastructure 104 to a second processing block 103 which further processes the system event. If a system event has been completely processed by the embedded system 100, it is output by means of the output system interfaces 102 to the environment of the embedded system 100, for example to another component of the overall system in which the embedded system 100 is embedded, i.e. of which it is a part.

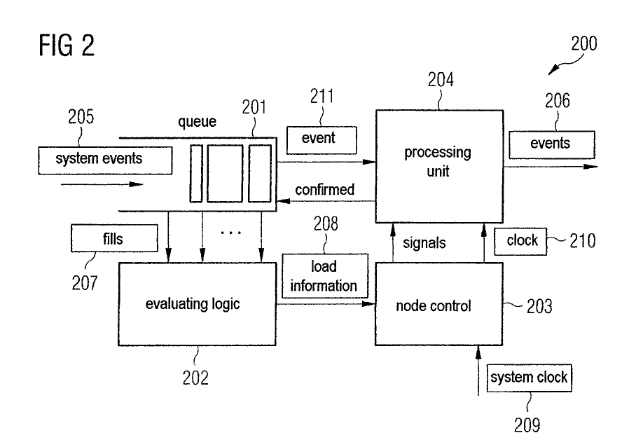

The processing blocks 103 are decoupled from one another by means of input queues as will be explained with reference to FIG. 2 in the text which follows.

FIG. 2 shows a processing block 200 according to an exemplary embodiment of the invention.

The processing block 200 corresponds to the processing blocks 103 shown in FIG. 1.

The processing block 200 has a queue 201, an evaluating logic 202, a node control 203 and a processing unit 204. System events 205 are supplied to the processing block 200 and first stored by means of the queue 201. If the processing unit 204 is ready for processing a system event 211, it confirms this to the queue 201 and the processing unit 204 is supplied with a system event 211 for processing.

Events 206 processed by the processing unit 204 are output by the processing block 200 and to a further one of the processing blocks 103 or to the output system interfaces 102 depending on the arrangement of the processing block 200 in the embedded system 100.

The processing power of the processing unit 204 is controlled by means of the queue 201, the evaluating logic 202 and the node control 203 as will be described in the text which follows.

The fill level 207 of the queue 201 is reported to the evaluating logic 202 by the queue 201. The evaluating logic 202 processes this information, generates load information 208 (for example a fill level value in the form of a fill level signal) and supplies this to the node control 203. From the load information 208, the node control 203 generates control variables for the processing power of the processing unit 204. For example, the node control 203 determines on the basis of the load information 208 control variables in accordance with which it switches the clock allocated to the processing unit 204 on or off, controls the clock frequency of the clock signal supplied to the processing unit 204 or adapts the supply voltage supplied to the processing unit 204.

In the present exemplary embodiment, the system clock 209 is supplied to the node control 203 and the node control 203 generates from the system clock 209, taking into consideration the load information 208, the processing unit clock 210 which it supplies to the processing unit 204.

Due to the modular configuration of the processing block 200, the queue 201, the evaluating logic 202 and the node control 203 can be implemented independently of one another. One possible implementation will be described in the further text.

The queue 201 is arranged, for example, as FIFO (First In First Out) queue. It can also be arranged as LIFO (Last in First Out) queue, i.e. as a stack. Furthermore, system events 205 stored in the queue 201 can also be processed by the processing unit 204 in accordance with other processing sequences, for example on the basis of the source from which the system events 205 are supplied to the processing block 200, in accordance with a round-robin method or by taking into consideration prioritizations. It is also possible to provide a number of queues 201 which are processed in accordance with a particular order, for example also in accordance with a round-robin method.

In the case where the queue 201 is arranged as a FIFO queue, the oldest system event 205, i.e. the system event supplied first to the processing block 200 of the system events 205 stored in the queue 201, which has not yet been processed, is available immediately after its storage in the queue 201 and permanently readable at the output of the queue 201 until it has been completely processed, until the processing unit 204 has confirmed the processing of the system event 211 and is thus ready for processing the next system event of the system events 205.

After this confirmation, the system event 211 processed is deleted from the queue 201 and the next oldest one of the system events 205 (now the oldest system event) is provided readably for the processing unit 204 at the output of the queue 201.

The fill level 207 is output by the queue 201, for example in the form of at least one flag. A single flag which specifies whether the queue 201 is presently empty or not empty only provides for rough control of the processing power of the processing unit 204, for example switching-on and -off of the processing unit 204 whereas a number of flags provide for gradual adaptations of the processing power. For example, the states full (100%), almost full (75%), almost empty (25%), empty (0%) of the queue 201 can be specified.

In the present embodiment, an ordered set of flags specifies the fill level 207 of the queue 201 according to table 1.

TABLE 1

| | |
|---|---|
| 00000000 | queue empty |
| 00000001 | fill level 1 |
| 00000011 | fill level 2 |
| 00000111 | fill level 3 |
| . . . | . . . |
| 11111111 | queue full |

In table 1, the fill levels rise from top to bottom. The fill level of the queue is here specified by means of a unary representation, that is to say by means of a numerical value which is specified in unary manner. In this conjunction, unary means that a number is represented by a corresponding number of ones (beginning from the right) which is fill leveled up with zeros (here to 8 digits). Although 2 digits are used, the numerical representation used is not a binary representation.

As mentioned, the processing block 200 can have a number of queues and system events can be stored in a particular queue of the plurality of queues on the basis of their priority. Furthermore, the length of the queues can be different. Output queues can also be provided in which the processing unit 204 stores the processed system events 206. In this case, the processing power of the processing unit 204 can be controlled on the basis of the fill level (or of the fill levels in the case of a number of output queues) of the output queue(s).

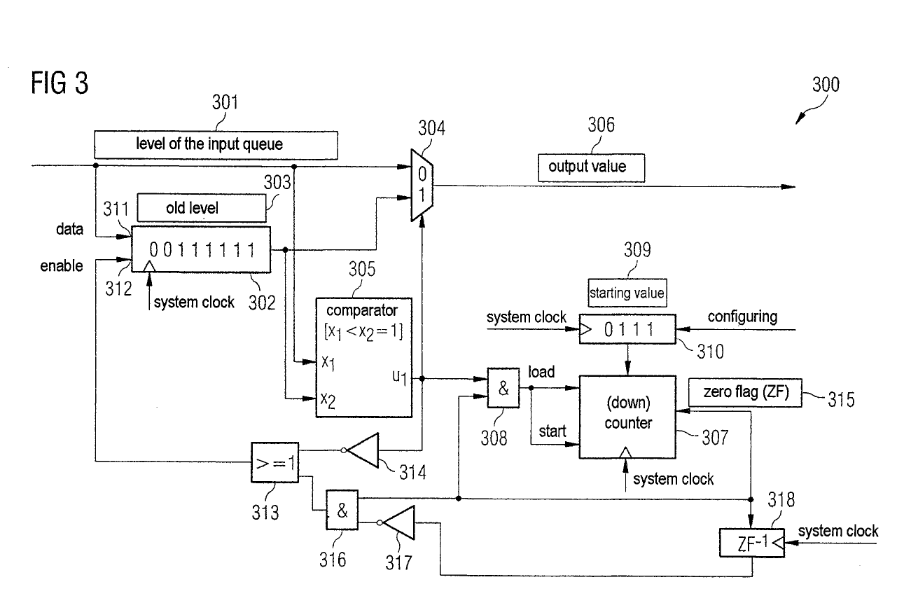

A possible implementation of the evaluating logic 202 will be explained with reference to FIG. 3 in the text which follows.

FIG. 3 shows an evaluating logic 300 according to an exemplary embodiment of the invention.

The evaluating logic 300 receives as input information about the fill level of the queues 201 (load information) in the form of a level of the input queue 301 which, in the present examples, is supplied to the evaluating logic 300 in the form of a unary word according to table 1.

An old level 303 of the queue 201 is stored in a memory 302. The old level 303 and the level of the input queue 301 are supplied to a multiplexer 304. Furthermore, the level of the input queue 301 and the old level 303 are supplied to a comparator 305. At the output of the comparator 305, designated by uI in FIG. 3, a 1 is present if the level of the input queue 301 is lower than the old level 303, and 0 if the level of the input queue 301 is greater than or equal to the old level 303.

The value present at the output of the comparator 305 is supplied to the control input of the multiplexer 304 so that the level of the input queue 301 is present at the output of the multiplexer 304 when the level of the input queue 301 is greater than or equal to the old level 303, and the old level 303 is present at the output of the multiplexer 304 when the level of the input queue 301 is lower than the old level 303.

The value at the output of the multiplexer 304 (also in unary representation according to table 1) forms the output value 306 of the evaluating logic 300.

The evaluating logic 300 also has a counter 307 which is set up for counting down when a 1 is present at the output of an AND gate 308. The counter counts down (to the value 0 at a maximum) starting from a starting value 309 which is stored in a further memory 310 and is preset depending on the configuration of the evaluating logic 300. The counter 307 begins to count down starting from the starting value 309 when a binary 1 is present at the output of the AND gate 308. This means that when a 1 is output by the AND gate 308, the counter 307 is loaded with the starting value 309 and is started. The counter 307 thus only starts starting with its starting value 309 when the count of the counter 307 has reached the value zero.

The AND gate 308 is supplied with the output value of the comparator 305 and a bit which is exactly 1 when the count of the counter 307 is 0, that is to say a zero flag 315. Thus, a binary 1 is present at the output of the AND gate 308 precisely when the count of the counter 307 is 0 and the level of the input queue 301 is lower than the old level 303.

The data input 311 of the memory 302 is supplied with the level of the input queue 301 which is stored in the memory 302 if a 1 is present at the enable input 312 of the memory 302. The output value of an OR gate 313 is present at the enable input 312. The OR gate 313 receives as input values the output value of a further AND gate 316 and the output value, negated by a NOT gate 314, of the comparator 305. The further AND gate 316 receives as input values the zero flag 315 and the content, inverted by an inverter 317, of a flip-flop 318 which is supplied with the zero flag 315. The flip-flop 318 illustratively stores the preceding zero flag and thus supplies a zero flag delayed by one clock period.

If the counter 307 has thus just counted to zero in a clock period, the zero flag 315 has the value 1 but in the flip-flop 318, the value 0 is still stored (until the next clock pulse). The AND gate 316 which is supplied with the zero flag 315 and the negated zero flag delayed in the flip-flop 318 accordingly supplies the value 1 and the old level 303 is overwritten.

The evaluating logic 300 thus implements a time-controlled hysteresis effect because in the case of falling levels, the old level 303 is only overwritten with a new (smaller) value when the counter 307 has counted down to zero. Before that, the zero flag has the value 0 so that the AND gate 316 supplies the value 0. In addition, the NOT gate 314 also supplies a zero in the case of falling levels so that the OR gate 313 supplies a zero. Depending on the current level of the input queue 301, either the level of the input queue 301 itself (in the case of rising levels) or the old level 303 (in the case of dropping levels) is output. This reduces the variations in processing (and of the output value 306) due to short-term changes in the fill level of the queue 201. The hysteresis is time-controlled by the counter 307.

The evaluating logic can also be provided without hysteresis so that the level of the input queue 301 is equal to the output value 306. Furthermore, a fill level-controlled hysteresis can be provided in which the output value 306 changes only when the level of the input queue 301 changes.

As mentioned above, it can be provided that a number of queues are present and/or that the system events supplied to the processing block 200 are prioritized. For example, differently prioritized system events are stored in different input queues. In this case, the evaluating logic 202 could combine, for example, the individual fill levels of the input queues weighted in accordance with their priorities by means of an OR circuit so that a common fill leveling level according to the level of the input queue 301 is generated which is processed, for example, by the evaluating logic 300 shown in FIG. 3.

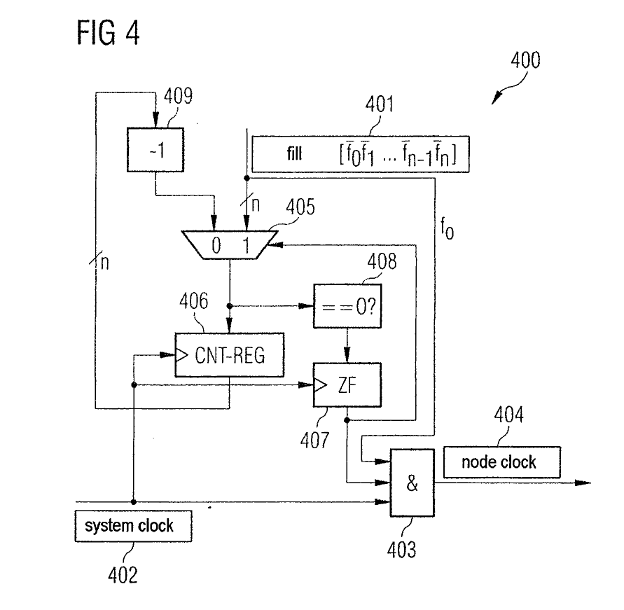

In the text which follows, a possible implementation of the node control 203 is explained with reference to FIG. 4.

FIG. 4 shows a node control 400 according to an exemplary embodiment of the invention.

As explained with reference to FIG. 2, the node control 400 is supplied with a fill level value. In the present examples, the format of the fill level value corresponds to the format illustrated in table 1 (i.e. a unary representation). The fill level value thus exhibits digits fₙ to f₀ which in each case assume the value 0 or 1. f₀ here corresponds to the “least significant” digit, i.e. to the digit shown at the far right in table 1. Correspondingly, fₙ corresponds to the “most significant” digit of the fill level value.

In the present exemplary embodiment, the node control 400 does not use the fill level value itself but a negated fill level value 401 in which all digits are negated compared with the fill level value and the order of which is reversed. The negated fill level value 401 thus consists of digits f̅₀ to f̅ₙ, which are the negated digits of the fill level value. The negated fill level value 401 is generated from the fill level value, for example by n+1 inverters (not shown). f̅₀ is the “most significant digit” of the negated fill level value 401 in the sense of the unary representation and f̅ₙ is the “least significant” digit of the negated fill level value 401 in a sense of the unary representation.

An AND gate 403 is supplied with the system clock 402. The output of the AND gate 403 is a node clock 404 which corresponds to the processing unit clock 210 which is supplied to the processing unit 204. The AND gate 403 is supplied with the least significant digit of the fill level value f₀. The AND gate 403 thus supplies a node clock 404, i.e. a rising edge of the clock signal or a high level (binary 1) in a clock period, at the most when the fill level value is not 0, that is to say the queue 201 is not empty (please note the unary representation of the fill level value according to table 1). Thus, the processing unit 204 is not supplied with a node clock 209 when the queue 201 is empty. The processing unit 204 is thus switched off in this case.

The digits apart from the most significant digit of the negated fill level value 401, that is to say digits f̅₁ to f̅ₙ, are supplied to a multiplexer 405 and output by the multiplexer 405 to a counter register 406 when the content of a flip-flop 407 which stores a zero flag (0 flag) is 1, that is to say the stored zero flag is set.

The zero flag is set by a comparator 408 exactly when the output value of the multiplexer 405 is 0. The flip-flop 407 is supplied with the system clock 402 and the state of the flip-flop can only change in accordance with the system clock, for example in the positive half-wave of the clock signal or with a positive edge of the system clock 402 (depending on the design of the flip-flop 407).

The counter register 406 is built up from a plurality of flip-flops, the state of which can also change only once per clock period (for example with a positive edge of the system clock 402). The counter register 406 outputs the value currently stored in it to a decrementing unit 409 which decrements the value by 1 and supplies this decremented value to the multiplexer 405. The multiplexer 405 switches the decremented value through to its output value exactly when the zero flag is not set, and the value 0 is accordingly stored in the flip-flop 407.

Illustratively, the negated fill level value 401 (without the most significant digit), when the zero flag is not set, is thus stored in the counter register 406, decremented by 1 per clock period of the system clock 402 until the value 0 is reached whereupon the zero flag is set to the value 1 and the negated fill level value 401 (without the most significant digit) is again stored in the counter register 406 (by means of the multiplexer 405).

The zero flag is also supplied to the AND gate 403. Thus, the AND gate 403 outputs a binary 1 (and thus a positive half period for the node clock 404) exactly when a positive half period of the system clock 402 is present, the fill level value is not 0 and when the value 1 is stored in the flip-flop 407.

Illustratively the node control 400 acts as frequency divider for the system clock 402. The higher the fill level value the lower the negated fill level value 401 and the higher the node clock 404 since fewer clock periods are required for decrementing the value stored in the counter register 406 to zero. In this manner, the node control 400 controls the spacing of second positive half-waves of the node clock 404 in dependence on the fill level and thus achieves clock gating.

By this means, the node control 400, by using the fill level value supplied to it by the evaluating logic 202, controls the processing power of the processing unit 204.

Depending on embodiment, the number of flip-flops of which the counter register 406 consists can be different so that different variants of the node control 400 are obtained. Correspondingly, only a part of the positions of the fill level value can be taken into consideration for node control. More flexible embodiments are also possible, for example a memory-based embodiment in which a table with values is provided and the counter register 406 is loaded with the value from the table (for example a fast-access lookup table) which is indexed by the current fill level value. By allocating a value in the table to each fill level, an individual clock rate of the node clock 404 can thus be set for each fill level.

What is claimed is:

1. A data processing arrangement including a plurality of processing units, each processing unit comprising:
a processing element;
a data memory, wherein the processing element processes data stored in the data memory, or the data memory stores results of data processing performed by the processing element;
a fill level unit generating a fill level signal signaling an amount of data stored in the data memory; and
a control unit controlling processing power of the processing element based on the fill level signal.

2. The data processing arrangement of claim 1, wherein the control unit controls a clock rate of the processing element or a supply voltage of the processing element based on the fill level signal.

3. The data processing arrangement of claim 1, wherein the data memory is an input queue in which data which are to be processed by the processing element are stored.

4. The data processing arrangement of claim 3, wherein the data stored in the input queue are processed by the processing element in accordance with FIFO, LIFO, or a prioritization of the data.

5. The data processing arrangement of claim 1, wherein at least one processing unit has a plurality of data memories storing data which are to be processed by the processing element of the processing unit.

6. The data processing arrangement of claim 5, wherein the fill level unit generates a fill level signal signaling an amount of data stored in the data memories.

7. The data processing arrangement of in claim 6, wherein the plurality of data memories are prioritized with respect to one another and the fill level signal is generated based on the prioritization of the plurality of data memories.

8. The data processing arrangement of claim 1, wherein the data memory is an output queue in which data which have been processed by the processing element are stored.

9. The data processing arrangement of claim 1, wherein an input signal for the control unit is generated from the fill level signal in accordance with a hysteresis, and the control unit controls the processing power of the processing element based on the input signal.

10. The data processing arrangement of claim 1, wherein the processing element is programmable.

11. The data processing arrangement of claim 1, wherein the processing element is a microprocessor.

12. A method for controlling a data processing arrangement having a plurality of processing units, each processing unit having a processing element, a fill level unit, a control unit, and a data memory, the processing element processing data stored in the data memory or storing in the data memory results of the processing of data, the method comprising:
the fill level unit generating a fill level signal signaling an amount of data stored in the data memory; and
the control unit controlling processing power of the processing element based on the fill level signal.

13. A data processing arrangement having a plurality of processing units, wherein each processing unit comprises:
a processing element;
a data memory, wherein the processing element processes data stored in the data memory, or the data memory stores results of data processing performed by the processing element;
a fill level unit generating a fill level signal signaling an amount of data stored in the data memory;
a generating unit generating an input signal for the control unit from the fill level signal in accordance with a hysteresis; and
a control unit controlling processing power of the processing element based on the input signal.

14. A data processing arrangement including a plurality of processing units, each processing unit comprising:
a processing means for processing data stored in a data memory means;
the data memory means for storing results of data processing performed by the processing means;
a fill level means for generating a fill level signal signaling an amount of data stored in the data memory means; and
a control means for controlling processing power of the processing means based on the fill level signal.

15. The data processing arrangement as claimed in claim 14, wherein the control means is also for controlling a clock rate of the processing means or a supply voltage of the processing means based on the fill level signal.

16. A data processing arrangement having a plurality of processing units, wherein each processing unit comprises:
a processing means for processing data stored in a data memory means;
the data memory means for storing results of data processing performed by the processing means;
a fill level means for generating a fill level signal signaling an amount of data stored in the data memory means;
a generating means for generating an input signal for the control means from the fill level signal in accordance with a hysteresis; and
a control means for controlling processing power of the processing means based on the input signal.
